(19) United States
(12) Patent Application Publication
(10) Pub. No.: US 2023/0291679 A1
(43) Pub. Date: Sep. 14, 2023

(54) DYNAMIC USE OF A PACKET RECOVERY MECHANISM TO AVOID CONGESTION ALONG A NETWORK PATH

(71) Applicant: Cisco Technology, Inc., San Jose, CA (US)

(72) Inventors: Giulio Grassi, Paris (FR); Jacques Olivier SAMAIN, Paris (FR); Michele PAPALINI, Issy Les Moulineaux (FR); Giovanna CAROFIGLIO, Paris (FR)

(21) Appl. No.: 17/690,130

(22) Filed: Mar. 9, 2022

(51) Int. Cl. H04L 45/125; H04L 45/12; H04L 45/24; H04L 45/42; H04L 47/122

(52) U.S. Cl. CPC H04L 45/125; H04L 45/123; H04L 45/24; H04L 45/42; H04L 47/122

(57) ABSTRACT

In one embodiment, a device executing an application estimates capacity metrics for paths between the device and a data source from which the device pulls data associated with the application. The device estimates a number of data requests by the device that must be pending with the data source to maintain synchronization with the application. The device determines an amount of capacity of the paths to be used by a packet recovery mechanism without causing congestion, based on the capacity metrics for the paths between the device and the data source and the number of data requests by the device that must be pending with the data source to maintain synchronization. The device requests, from the data source, use of the packet recovery mechanism for the data associated with the application, according to the amount of capacity of the paths to be used by the determined packet recovery mechanism.

### TECHNICAL FIELD

The present disclosure relates generally to computer networks, and, more particularly, to the dynamic use of a packet recovery mechanism to avoid congestion along a network path.

### BACKGROUND

Real-time communication (RTC) is sensitive to changes in link capacity or congestion. Generally, when a link or part of path between two devices is momentarily not enough to sustain both requested data as well as reliability data (e.g., packets dedicated for a packet recovery mechanism), an application that expects to receive the overall data may not have sufficient time to react, address, correct, etc. issues caused by the loss of capacity on a given link or path. Changes like these may adversely affect end user's Quality of Experience (QoE), which may be understood a subjective assessment of an application experience from the standpoint of a user of the application.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for devices using a pull-based communications protocol, specifically Hybrid Information-Centric Networking (hICN);

FIG. 4 illustrates an example architecture for devices using a pull-based communications protocol, specifically hICN, and real-time communication (RTC);

FIG. 5 illustrates an example architecture for the dynamic use of a packet recovery mechanism to avoid congestion along a network path;

FIGS. 6A-6C illustrate various example estimated link capacity and data request diagrams; and

FIG. 7 illustrates an example simplified procedure for the dynamic use of a packet recovery mechanism to avoid congestion along a network path.

### DESCRIPTION OF EXAMPLE EMBODIMENTS

### Overview

According to one or more embodiments of the disclosure, a device executing an application estimates capacity metrics for one or more paths between the device and a data source from which the device pulls data associated with the application. The device estimates a number of data requests by the device that must be pending with the data source to maintain synchronization with the application. The device determines an amount of capacity of the one or more paths to be used by a packet recovery mechanism without causing congestion, based on the capacity metrics for the one or more paths between the device and the data source and the number of data requests by the device that must be pending with the data source to maintain synchronization with the application. The device requests, from the data source, use of the packet recovery mechanism for the data associated with the application, according to the amount of capacity of the one or more paths to be used by the packet recovery mechanism determined by the device.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

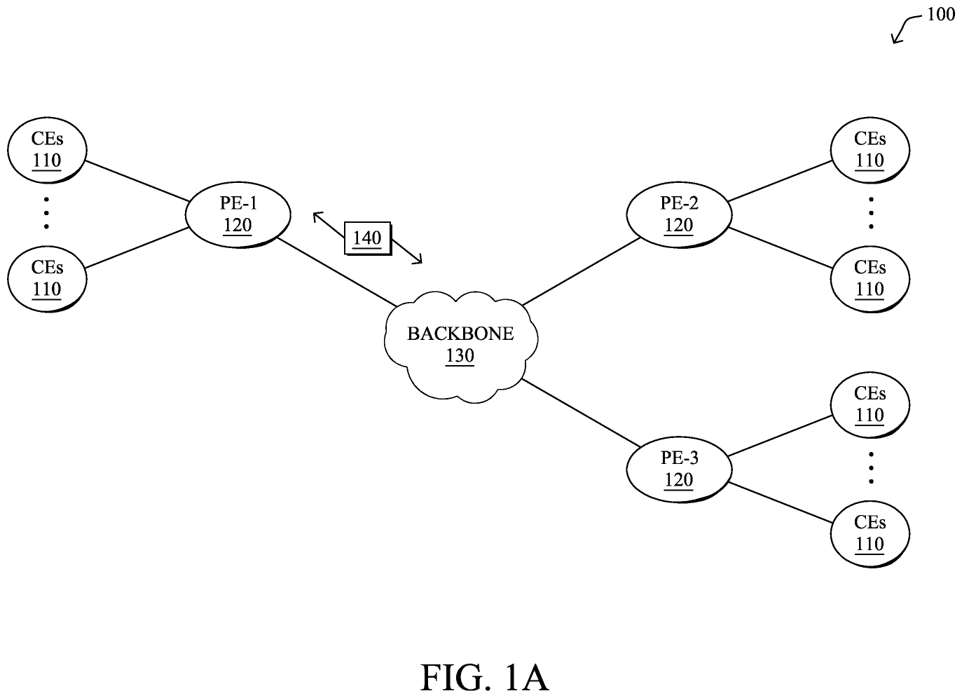

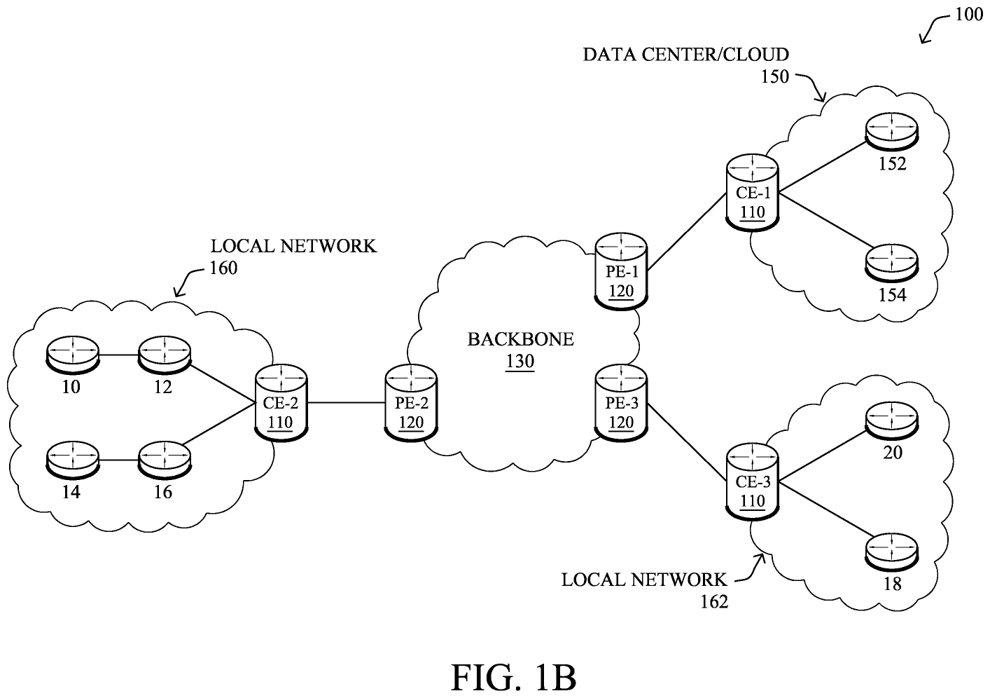

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

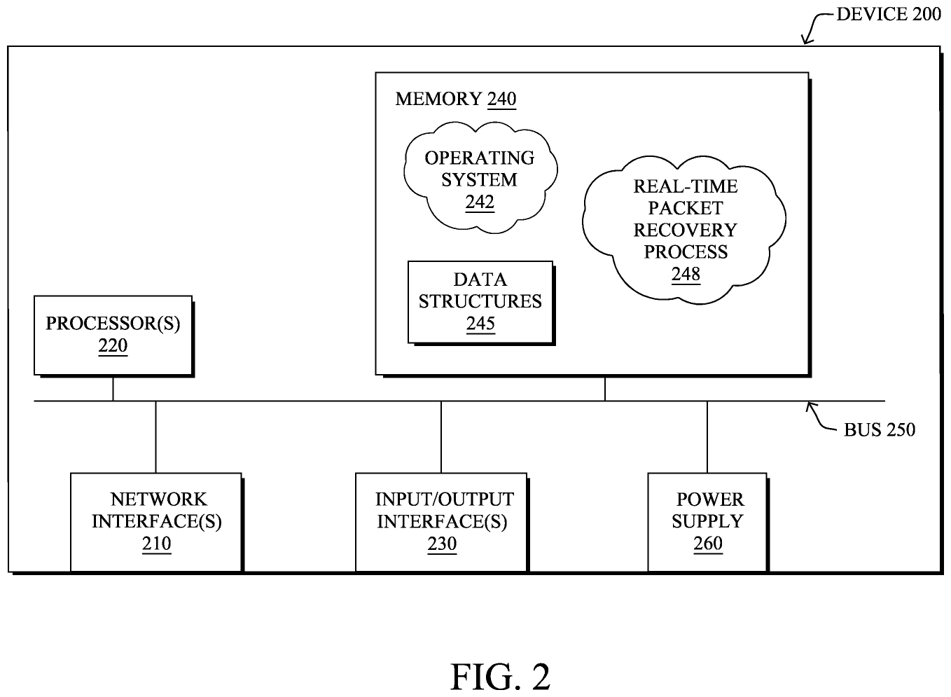

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, physical network interfaces 210 may also be used to implement one or more virtual network interfaces, such as for virtual private network (VPN) access, known to those skilled in the art. As is understood in the art, network interfaces 210 may comprise a plurality of network interfaces used for a variety of networking communication protocols, for example, Wi-Fi, cellular (LTE, 5G, etc.), Bluetooth, etc.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise real-time packet recovery process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

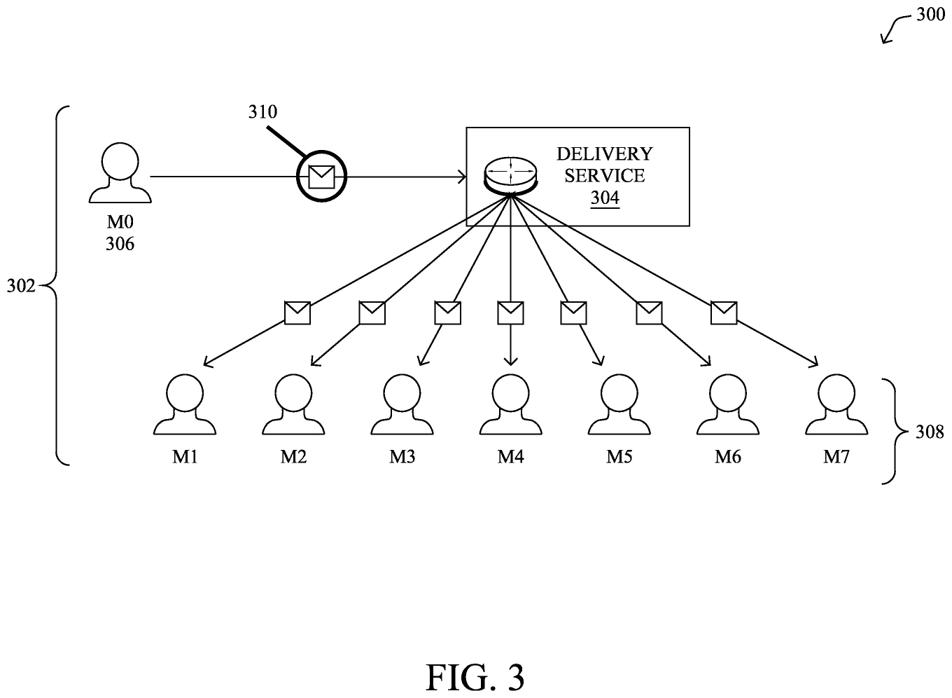

In some communications networks, communications among devices may be based on a pull-based model, where a device may request, at varying intervals of time, information from a source (e.g., another device, a server, etc.). Of note, an example of a pull-based communications protocol is hybrid Information-Centric Networking (hICN), where hICN has been introduced to jointly provide reliable multicast communication support in a publisher/subscriber mode. Such support enables the ability to realize multicast groups under unicast IP transport conditions. For example, FIG. 3 illustrates an example architecture 300 for devices using a pull-based communications protocol, specifically hybrid Information-Centric Networking (hICN). As shown, architecture 300 may include a plurality of group members 302 (e.g., comprising mobile devices like cellphones, tablets, etc.) that are configured to communicate with one another using hICN. hICN, generally, is an architecture that brings information-centric networking into Internet Protocol version 6 (IPv6), and, by doing so, enables generalization of IPv6 networking by using location-independent name-based networking. This may be enabled at either a network layer and/or at a transport layer by also providing name-based sockets to applications. By reusing and extending existing IPv6 protocols and architectures, hICN provides deployable hybrid solutions that are tailored to various use cases and application needs.

Each of plurality of group members 302 may be equipped, configured, etc. with one or more hICN transport services, for example, by using one or more application programming interface (APIs) (e.g., producer-consumer, publisher-subscriber, push-pull, etc.). That is, a producer/publisher (e.g., over a communication socket) may be implemented such that it binds a name prefix, where the name prefix may be used to pull data, information, etc. by consumers/subscribers (e.g., over a communication socket). Generally, an hICN name prefix may be an internet protocol version 6 (IPv6) address number, as defined in hICN. Further, an hICN name prefix is understood to be a location independent name (topic, data identifier, etc.) that hides network topologies details to both consumers and producers (e.g., among plurality of group members 302). Content that may be published from one group member to the other group members may include various or streams, including audio and/or video streams, teleconference information, a commit message that is used to update group membership or create Messaging Layer Security (MLS) groups, application messages, etc.

In the example shown in FIG. 3, delivery service 304 may be configured to use a hICN based broadcast service that is configured to publish content from group member 306 to group members 308. Similarly, group members 308 may be equipped, configured, etc. with one or more hICN transport services, for example, by using one or more APIs. It is, however, contemplated that for certain hICN applications do not require delivery service 304 and that requests may be sent from each of group members 308 to group member 306 (and vice versa). In the example shown in FIG. 3, message 310 sent by group member 306 may include requested application information/data that is to be “pulled” directly from group members 308 or via delivery service 304.

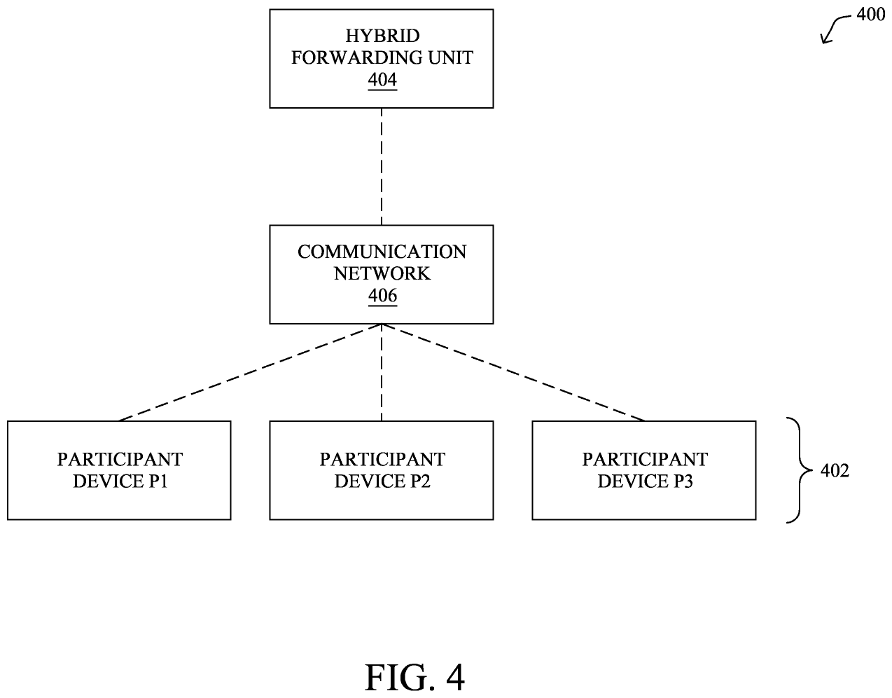

It is contemplated that hICN, in some conditions, may be well-suited for real-time communication (RTC). That is, hICN, may be implemented alongside a protocol such as WebRTC that includes a selective forwarding unit (SFU)-based architecture where transport layer communications are synchronized among “consumer” devices and “producer” devices. Particularly, with reference FIG. 4, an example architecture 400 of a pull-based communications protocol, specifically hICN, and RTC is shown (which may be understood as a hICN-RTC architecture). Architecture 400 includes a plurality of participant devices 402 (also referred to as “participants” or “clients” P1-P3) operated by/associated with respective users of the participant devices, and hybrid forwarding unit 404 configured to connect to, and communicate with, each of the participant devices over a communication network 406. Communication network 406 may include one or more wide area networks (WANs), such as the Internet, and one or more local area networks (LANs). Communication network 406 may also include an ICN network to which participant devices P1-P3 and hybrid forwarding unit 404 connect to communicate with each other.

Architecture 400 supports communication sessions between participant devices P1-P3, such as a conference between the users of the participant devices, in which the participant devices connect to hybrid forwarding unit 404 and exchange multimedia content with each other through hybrid forwarding unit 404. The multimedia content may include audio in the form of audio streams, video in the form of video streams, text, chat, and so on, associated with users of the participant devices. To this end, hybrid forwarding unit 404 operates as a central or intermediate network device/node for streaming of audio and video among plurality of participant devices 402 when connected to the hybrid forwarding unit. For example, a given participant device may send its associated audio stream and video stream to hybrid forwarding unit 404. Hybrid forwarding unit 404 may then decide which of the streams to forward to the remaining devices. This adds flexibility as hybrid forwarding unit 404 may decide to drop streams that are deemed not important and to forward only the important ones, such as the streams from “active speaker” participant devices (i.e., participant devices deemed to be associated with users of the participant devices who are active speakers/talkers) among the participant devices. The selection of which streams to forward may be achieved without any media processing at hybrid forwarding unit 404, to avoid inducing extra delay or processing at the hybrid forwarding unit 404 (or at plurality of participant devices 402).

Architecture 400 may build upon the WebRTC SFU-based architecture and adapts it to hICN by: (i) hICN integration at the participant devices (e.g., plurality of participant devices 402) and at the hybrid forwarding unit (e.g., hybrid forwarding unit 404), (ii) minimal modifications to the interaction with the application-layer, and (iii) implementing an RTC-tailored hICN transport protocol. In hICN-RTC, participant devices and the hybrid forwarding unit may include, for example: a) WebRTC application logic (e.g., encoding/decoding audio and video flows at the participant devices and forwarding streams without any transcoding operation at the hybrid forwarding unit); b) an hICN transport to carry video flows and/or audio flows between participant devices and the hybrid forwarding unit in hICN packets; and c) an hICN forwarder operating on hICN packets. hICN-RTC modifies the interaction between the application and the network transport to exploit aggregation and multicasting features of the underlying hICN network. It is contemplated that an ad-hoc hICN naming scheme and a new communication flow between participant devices and hybrid forwarding unit may be defined, which are transparent to a given WebRTC participant device (e.g., client) and hybrid forwarding unit application and/or device.

In accordance with the naming scheme, the video of/from each participant device (i.e., the video associated with a participant device in a conference) is named using (i) a participant specific name_prefix, e.g., /video/participant-1/for video from participant device P1, and (ii) a set of pre-defined name_prefixes, e.g., /video/active-speaker-1/for participant device P1, /video/active-speaker-2/for participant device P2, . . . , /video/active-speaker-n/for participant device Pi, to name the video streams of (i.e., associated with) the “active speaker” participant devices associated with users who are active speakers in the conference. The communication between the hybrid forwarding unit 404 and a hICN-RTC enabled participant device works as follows: the hICN transport layer at hybrid forwarding unit pulls the video of the participant devices identified as being associated with users who are active speakers (i.e., from the active speaker participant devices), and re-names their video using the active speaker participant devices' name_prefixes. At the participant devices, the hICN transport layer pulls the video of the active speaker participant devices from the hybrid forwarding unit, using the active speaker participant devices name_prefixes, e.g., /video/active-speaker-1/. This approach allows a reduction in the overhead at the application for two reasons: (i) since all of the participant devices request the same set of videos through the hybrid forwarding unit, i.e., the videos of the active speaker participant devices, the requests from all of the participant devices are aggregated and satisfied by the hICN forwarder in the hybrid forwarding unit. Thus, only a small portion of requests reaches the hybrid forwarding unit application; and (ii) in hICN-RTC, the hybrid forwarding unit pulls only the video from the active speaker participant devices, rather than retrieving the video streams from all of the participant devices including active speaker participant devices and non-active speaker participant devices (e.g., associated with users who are not considered/determined to be active speakers) and dropping those belonging to the non-active speaker participant devices. Therefore, only the streams that are really needed are requested.

As noted above, real-time communication (RTC), for example, those provided in hICN-RTC networks, is sensitive to changes in link capacity or congestion, where a link may be understood as links between two devices or part of (or an entire) path between a device and another device (which may include a plurality of a device). Generally, when part of a link or a path between two devices is momentarily not enough to sustain both requested data as well as reliability data (e.g., packets dedicated for a packet recovery mechanism), an application that expects to receive the overall data may not have sufficient time to react, address, correct, etc. issues caused by the loss of capacity on a given link or path. In the context of streaming for video streams, audio streams, etc., the application may be configured to suddenly modify video and/or audio quality, which may be an overcorrection (or drastic) solution to short-term degradation to link capacity. Changes like these may adversely affect end user's Quality of Experience (QoE), which may be understood a subjective assessment of an application experience from the standpoint of a user of the application.

### Dynamic Use of a Packet Recovery Mechanism to Avoid Congestion Along a Network Path

The techniques herein introduce mechanisms for the dynamic use of a packet recovery mechanism to avoid congestion along a network path. Specifically, pull-based communications protocols (e.g., real-time communication (RTC) protocols), where data requesters (or consumers) are configured to request data from providers (or data sources) for retrieval of each piece of data (e.g., for a stream of data), may be configured to dynamically modify its requests and, consequently, its demand on a communications network (e.g., an hICN-RTC network). A reliability budget mechanism may be introduced such that an application is aware of path and/or link conditions between a device (where the application in installed) and the network. Based on the monitored network conditions as well as the application's awareness of its currently pending data requests for real-time communications information, the application may dynamically modify its requests so as to optimize Quality of Experience (QoE) for a user of the application. Additionally, the application itself may be configured to operate based on directive(s), for example, governed by an application stakeholder, that may be different than directive(s) for another application.

Specifically, according to one or more embodiments of the disclosure as described in detail below, a device executing an application estimates capacity metrics for one or more paths between the device and a data source from which the device pulls data associated with the application. The device estimates a number of data requests by the device that must be pending with the data source to maintain synchronization with the application. The device determines an amount of capacity of the one or more paths to be used by a packet recovery mechanism without causing congestion, based on the capacity metrics for the one or more paths between the device and the data source and the number of data requests by the device that must be pending with the data source to maintain synchronization with the application. The device requests, from the data source, use of the packet recovery mechanism for the data associated with the application, according to the amount of capacity of the one or more paths to be used by the packet recovery mechanism determined by the device.

Illustratively, the techniques described herein may be performed by hardware, software, and/or firmware, such as in accordance with real-time packet recovery process 248, which may include computer executable instructions executed by the processor 220 (or independent processor of interfaces 210) to perform functions relating to the techniques described herein.

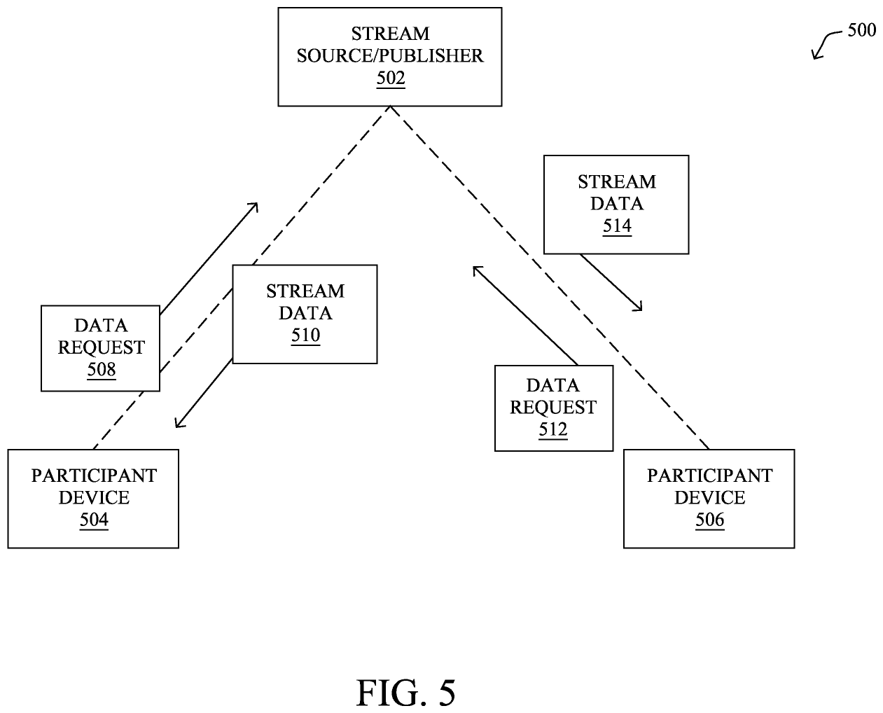

Operationally, FIG. 5 illustrates an example architecture for the dynamic use of a packet recovery mechanism to avoid congestion along a network path. Architecture 500 includes stream source/publisher 502 that is configured to execute an application that may receive and/or obtain data requests then respond to the requests with response data, including one or more real-time communications streams (e.g., audio streams, video streams, etc.). As shown, first participant device 504 and second participant device 506 along with stream source/publisher 502, may individually execute the application, and in certain scenarios, each of the participant devices may send and/or receive streams from stream source/publisher 502.

It is to be understood that the devices may operate according to a pull-based communications model (e.g., hICN-RTC, etc.) where a given data requester/consumer (e.g., first participant device 504 and second participant device) issues a data request to a data producer (e.g., stream source/publisher 502) for every piece (e.g. packet) of requested content. As soon as data producer receives the data request, the data producer may respond with the requested content. Generally, a consumer may have multiple data requests issued that have yet to be responded to be a producer (e.g., still waiting for the producer's replies), as is understood in the art. These yet to be satisfied requests may be understood as pending requests from a perspective of a given consumer. For various reasons, for instance, congestion in a network, degradation of network quality, etc. a device (and the application) may be adversely affected, thereby decreasing QoE of the application. Notably, many RTC and/or streaming applications conventionally require a synchronization window between requests sent by a device and responses to the requests by a data source. When the synchronization window is no longer synchronized, an application stream may be cut off, delayed, etc.

For example, first participant device 504 may first data request 508, then stream source/publisher 502 may reply to the request with stream data 510. Similarly, second participant device 506 may second data request 512, then stream source/publisher 502 may reply to the request with stream data 514. Prior to sending the data requests, each of the participant devices are configured to periodically (e.g., at a time interval like every 200 milliseconds (ms)) estimate:
a) capacity metrics for one or more paths or links between a given participant device and a data source, where the capacity metrics are generally indicative of an amount or number of data requests from a participant device may be pending at the data source without causing congestions (e.g., metrics may include link capacity like bandwidth, a congestion window, etc.); and
b) a number of data requests required to maintain synchronization for an application stream that reflects a rate with which the data source produces data for the application, where the number of data requests is indicative of a number of data requests from a participant device for a given application that must always be pending to remain in sync with the data source (e.g., this number may be a number of requests required to retrieve requested data generated no more than k ms from a particular point in time and may generally be computed as

$$production rate ⋆ \frac{round trip time ( R T T )}{packet size} ) .$$

Using the a) estimated capacity metrics and b) estimated number of data requests required to maintain synchronization, a given participant device may then determine an allocable amount of capacity that may be used for a packet recovery mechanism (e.g., retransmission error correction, forward error correction (FEC), etc.), which are generally used to ensure reliability of a stream of content. This may be understood as congestion window-sync. window, where the resultant excess (or lack of) capacity may from time-to-time be called a reliability budget (RB). The reliability budget may be understood as a number of retransmission/FEC packets to be requested or used to as close to zero percent loss rate (for a stream of content). In other words, at a per request basis, a participant device may determine a number of retransmission/FEC packets to be requested or used to as close to zero percent loss rate. This may from time-to-time be referred to as a reliability demand (RD).

In the event that reliability budget itself becomes zero, meaning that a participant device has estimated capacity to be lower than the number of data requests required to maintain synchronization, an application may be configured to enforce various stakeholder-configured directives. In an embodiment, these may be enforced via socket options for the application. For example, a particular application, upon detecting that reliability budget becomes zero (or below zero), may, at a per request level, estimate a delivery time of data requests yet to be sent (from a participant device) then drop those which cannot meet a deadline (provided by the application). In another example, another application may, at a per request level, maintain a data request rate close to the data source producer rate (thereby increasing a queueing delay) and, only when the consumer is out of sync (i.e., the participant device may be requesting content that is “too old” and not available anymore for a stream of data), jump forward to what the data source is currently generating so as to re-synchronize with the data source.

It is further contemplated that, in one or more embodiments, packets requested in data requests may have varying priority levels, for instance, “discardable” frames for a given application. In such embodiments, a participant device may, at a per data request level, may be configured to trade reliability with video quality by retrieving only the “most valuable” (according to various packet prioritization,) and only then start limiting reliability demand (as described herein above).

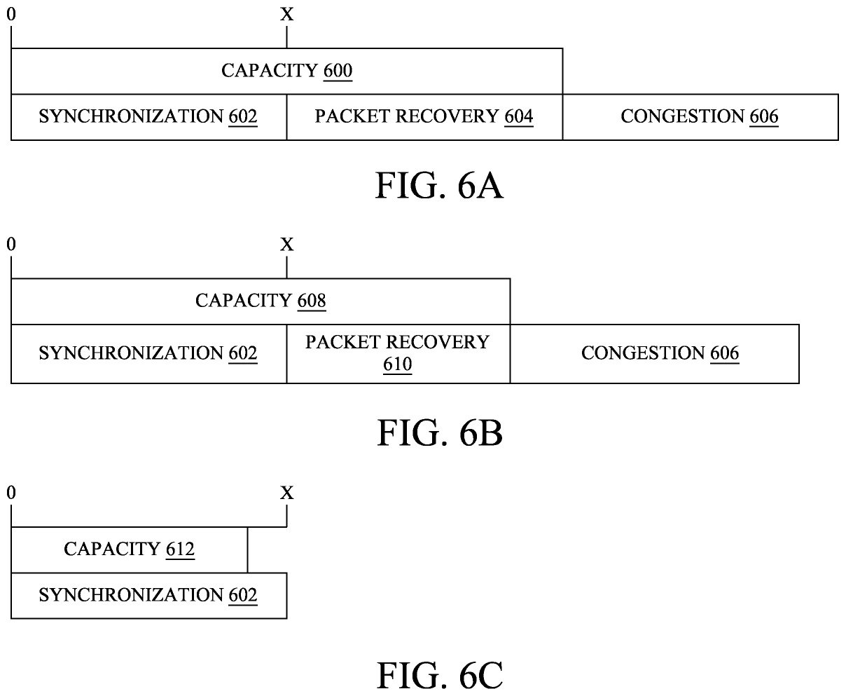

Turning to FIGS. 6A-6C, FIGS. 6A-6C illustrate various example estimated link capacity and data request illustrations. In FIG. 6A, a device may determine that, at a given time, capacity 600 for a network path is available for its next data request, for example, for a stream of data. In addition, the device may determine, according the techniques described herein, a number of synchronization packets 602 that are required. Because the number of synchronization packets 602 is less than the capacity 600, it can allocate a number of packet recovery packets 604 to a data request (e.g., for retransmission error correction or FEC) for reliability. Any additional packets would result in congestion 606.

In FIG. 6B, the device may determine that, at another given time, capacity 608 for a network path is available for its next data request, for example, for the same stream of data as in FIG. 6A. The device may also determine, according the techniques described herein, the same number of synchronization packets 602 that are required. Because the number of synchronization packets 602 is less than the capacity 608, it can allocate a number of packet recovery packets 610 to its next data request (e.g., for retransmission error correction or FEC). However, as shown, number of packet recovery packets 610 is fewer than number of packet recovery packets 604 because capacity 608 is smaller than capacity 600. Any additional packets would still result in congestion 606.

In FIG. 6C, an embodiment is shown where a device determines that capacity 612 is lower than that required for synchronization packets 602. In such case, the device may be configured to apply one or more directives that are application specific, as described herein above. For instance, device may at the next packet drop packets which cannot meet a deadline (provided by the application) or maintain a data request rate close to the data source producer rate (thereby increasing a queueing delay).

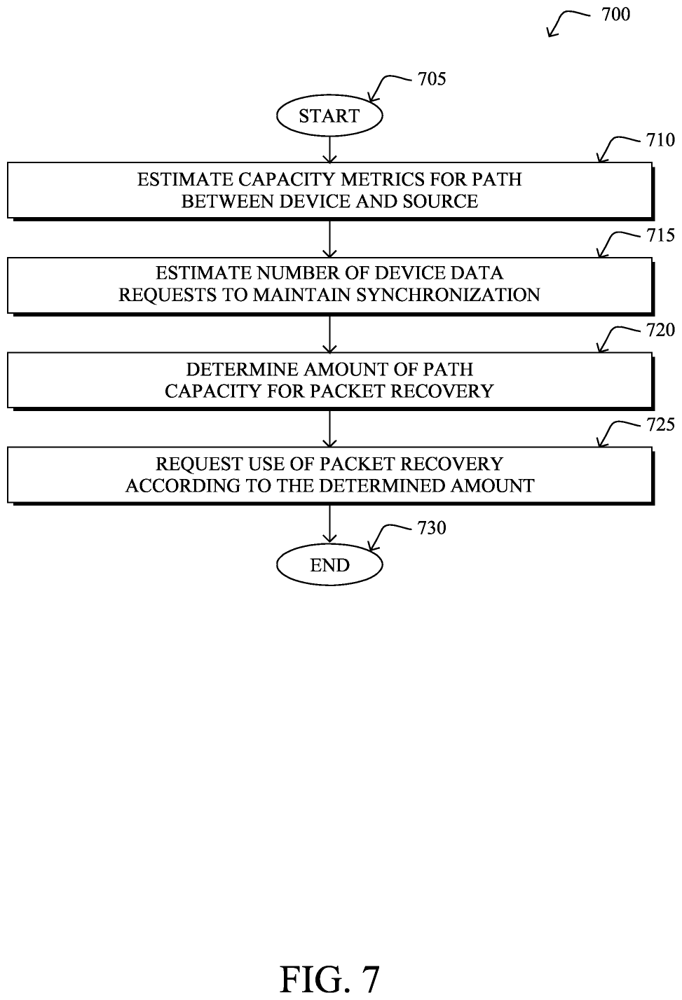

FIG. 7 illustrates an example simplified procedure (e.g., a method) for the dynamic use of a packet recovery mechanism to avoid congestion along a network path, in accordance with one or more embodiments described herein. For example, a non-generic, specifically configured device (e.g., device 200), may perform procedure 700 by executing stored instructions (e.g., real-time packet recovery process 248). The procedure 700 may start at step 705, and continues to step 710, where, as described in greater detail above, a device executing an application may estimate capacity metrics for one or more paths between the device and a data source from which the device pulls data associated with the application. In an embodiment, estimating the capacity metrics for the one or more paths between the device and the data source from which the device pulls data associated with the application may comprise the device determining a number of data requests that can be pending at the data source without causing congestion. In a further embodiment, the capacity metrics for the one or more paths between the device and the data source from which the device pulls data associated with the application may comprise a congestion window. In one or more embodiments, estimating the capacity metrics for one or more paths between the device and the data source from which the device pulls data associated with the application and estimating the number of data requests by the device that must be pending with the data source to maintain synchronization with the application may be performed periodically at an interval of time. In a further embodiment, the application may use hybrid Information-Centric Networking for communicating with the data source

At step 715. as detailed above, the device may estimate a number of data requests by the device that must be pending with the data source to maintain synchronization with the application. In an embodiment, estimating the number of data requests by the device that must be pending with the data source to maintain synchronization with the application may comprise determining

$$production rate ⋆ \frac{round trip time ( R T T )}{packet size} .$$

At step 720, the device may determine an amount of capacity of the one or more paths to be used by a packet recovery mechanism without causing congestion, based on the capacity metrics for the one or more paths between the device and the data source and the number of data requests by the device that must be pending with the data source to maintain synchronization with the application. In an embodiment, the amount of capacity of the one or more paths to be used by a packet recovery mechanism without causing congestion may be equal to a difference between the number of data requests that can be pending at the data source without causing congestion and the number of data requests by the device that must be pending with the data source to maintain synchronization with the application. In a further embodiment, the packet recovery mechanism may comprise retransmission-based error correction or forward error correction.

At step 725, as detailed above, the device may request, from the data source, use of the packet recovery mechanism for the data associated with the application, according to the amount of capacity of the one or more paths to be used by the packet recovery mechanism determined by the device. In an embodiment, the device may further drop one or more data requests that cannot meet a deadline of the application. In one or more embodiments, the device may further determine that the application has not maintained synchronization and may re-synchronize with the application based on requesting the use of the packet recovery mechanism for the data associated with the application. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a mechanism for the dynamic use of a packet recovery mechanism to avoid congestion along a network path. That is, a reliability budget mechanism may be introduced such that an application, using a pull-based communications model, is aware of path and/or link conditions between a device (where the application in installed) and a communications network. Based on the monitored network conditions as well as the application's awareness of its currently pending data requests for RTC information, the application may dynamically modify its requests so as to optimize QoE for a user of the application.

While there have been shown and described illustrative embodiments that provide the dynamic use of a packet recovery mechanism to avoid congestion along a network path, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well. In addition, while certain types of network packets, protocols, etc. are discussed herein, the techniques herein may be used in conjunction with any network packets, protocols, etc.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
estimating, by a device executing an application, capacity metrics for one or more paths between the device and a data source from which the device pulls data associated with the application;
estimating, by the device, a number of data requests by the device that must be pending with the data source to maintain synchronization with the application;
determining, by the device, an amount of capacity of the one or more paths to be used by a packet recovery mechanism without causing congestion, based on the capacity metrics for the one or more paths between the device and the data source and the number of data requests by the device that must be pending with the data source to maintain synchronization with the application; and
requesting, by the device and from the data source, use of the packet recovery mechanism for the data associated with the application, according to the amount of capacity of the one or more paths to be used by the packet recovery mechanism determined by the device.

2. The method as in claim 1, wherein estimating the capacity metrics for the one or more paths between the device and the data source from which the device pulls data associated with the application comprises:
determining a number of data requests that can be pending at the data source without causing congestion.

3. The method as in claim 2, wherein the amount of capacity of the one or more paths to be used by a packet recovery mechanism without causing congestion is equal to a difference between the number of data requests that can be pending at the data source without causing congestion and the number of data requests by the device that must be pending with the data source to maintain synchronization with the application.

4. The method as in claim 1, wherein the capacity metrics for the one or more paths between the device and the data source from which the device pulls data associated with the application comprise a congestion window.

5. The method as in claim 1, wherein estimating the number of data requests by the device that must be pending with the data source to maintain synchronization with the application comprises determining
$$production rate ⋆ \frac{round trip time ( R T T )}{packet size} .$$

6. The method as in claim 1, further comprising:
dropping, by the device, one or more data requests that cannot meet a deadline of the application.

7. The method as in claim 1, further comprising:
determining, by the device, that the application has not maintained synchronization; and
re-synchronizing, by the device, with the application based on requesting the use of the packet recovery mechanism for the data associated with the application.

8. The method as in claim 1, wherein estimating the capacity metrics for one or more paths between the device and the data source from which the device pulls data associated with the application and estimating the number of data requests by the device that must be pending with the data source to maintain synchronization with the application are performed periodically at an interval of time.

9. The method as in claim 1, wherein the packet recovery mechanism comprises retransmission-based error correction or forward error correction.

10. The method as in claim 1, wherein the application uses hybrid Information-Centric Networking for communicating with the data source.

11. An apparatus, comprising:
one or more interfaces;
a processor coupled to the one or more interfaces and configured to execute one or more processes; and
a memory configured to store a process that is executable by the processor, the process when executed configured to:
estimate, for one or more paths between the apparatus and a data source from which the apparatus pulls data associated with an application executing on the apparatus, capacity metrics;
estimate a number of data requests by the apparatus that must be pending with the data source to maintain synchronization with the application;
determine amount of capacity of the one or more paths to be used by a packet recovery mechanism without causing congestion, based on the capacity metrics for the one or more paths between the apparatus and the data source and the number of data requests by the apparatus that must be pending with the data source to maintain synchronization with the application; and
request, from the data source, use of the packet recovery mechanism for the data associated with the application, according to the amount of capacity of the one or more paths to be used by the packet recovery mechanism determined by the apparatus.

12. The apparatus as in claim 11, wherein to estimate the capacity metrics for the one or more paths between the apparatus and the data source from which the apparatus pulls data associated with the application comprises:
determining a number of data requests that can be pending at the data source without causing congestion.

13. The apparatus as in claim 12, wherein the amount of capacity of the one or more paths to be used by a packet recovery mechanism without causing congestion is equal to a difference between the number of data requests that can be pending at the data source without causing congestion and the number of data requests by the apparatus that must be pending with the data source to maintain synchronization with the application.

14. The apparatus as in claim 11, wherein the capacity metrics for the one or more paths between the apparatus and the data source from which the apparatus pulls data associated with the application comprise a congestion window.

15. The apparatus as in claim 11, wherein to estimate the number of data requests by the apparatus that must be pending with the data source to maintain synchronization with the application comprises determining
$$production rate ⋆ \frac{round trip time ( R T T )}{packet size} .$$

16. The apparatus as in claim 11, the process when executed further configured to:
drop one or more data requests that cannot meet a deadline of the application.

17. The apparatus as in claim 11, the process when executed further configured to:
determine that the application has not maintained synchronization; and
re-synchronize with the application based on requesting the use of the packet recovery mechanism for the data associated with the application.

18. The apparatus as in claim 11, wherein to estimate the capacity metrics for one or more paths between the apparatus and the data source from which the apparatus pulls data associated with the application and estimating the number of data requests by the apparatus that must be pending with the data source to maintain synchronization with the application are performed periodically at an interval of time.

19. The apparatus as in claim 11, wherein the packet recovery mechanism comprises retransmission-based error correction or forward error correction.

20. A tangible, non-transitory, computer-readable medium storing program instructions that cause a device to execute a process comprising:
estimating capacity metrics for one or more paths between the device and a data source from which the device pulls data associated with an application executing on the device;
estimating a number of data requests by the device that must be pending with the data source to maintain synchronization with the application;
determining an amount of capacity of the one or more paths to be used by a packet recovery mechanism without causing congestion, based on the capacity metrics for the one or more paths between the device and the data source and the number of data requests by the device that must be pending with the data source to maintain synchronization with the application; and
requesting, from the data source, use of the packet recovery mechanism for the data associated with the application, according to the amount of capacity of the one or more paths to be used by the packet recovery mechanism determined by the device.
